(19) United States
(12) Patent Application Publication
(10) Pub. No.: US 2017/0031543 A1
(43) Pub. Date: Feb. 2, 2017

(54) INFORMATION PROCESSING APPARATUS, CONTROL METHOD THEREFOR, INFORMATION PROCESSING SYSTEM, AND COMPUTER-READABLE STORAGE MEDIUM

(71) Applicant: CANON KABUSHIKI KAISHA, Tokyo (JP)

(72) Inventor: Yukio Numakami, Kawasaki-shi (JP)

(21) Appl. No.: 15/217,336

(22) Filed: Jul. 22, 2016

(30) Foreign Application Priority Data
Jul. 31, 2015 (JP) 2015-152700

(51) Int. Cl. G06F 3/0482; G06F 3/0483; H04N 7/15

(52) U.S. Cl. CPC G06F 3/0482; H04N 7/15; G06F 3/0483

(57) ABSTRACT

An information processing apparatus includes: a communication unit configured to receive data of a display screen including a plurality of display elements from another communication apparatus; a display control unit configured to cause a display unit to display the plurality of display elements associated with the data received by the communication unit to be switchable in accordance with a user instruction; and a notification unit configured to notify a user of reception of data of a new display element by the communication unit in response to the reception.

### BACKGROUND OF THE INVENTION

Field of the Invention

The present invention relates to an information processing apparatus, a control method therefor, an information processing system, and a computer-readable storage medium and, more particularly, to a technique for sharing a display screen between a plurality of apparatuses.

Description of the Related Art

For example, a teleconference system in which a window screen is distributed between remote sites via an intermediate apparatus and a plurality of remote display devices display the window screen in synchronism with each other has become widespread. This system can share and synchronously display a window screen between remote sites by distributing, to a display device at another site via an intermediate apparatus, window screen data created in a screen management server or a screen creation apparatus at a given site.

It is known that since such system communicates window screen data via a network, the transfer capacity of the screen data is reduced by converting the resolution of a display area to be operated and transmitting the screen data (Japanese Patent Laid-Open No. 2014-174847).

Consider a case in which a window screen is shared and synchronously displayed with a communication apparatus such as a smartphone having a low resolution and a small screen size. In this case, if the communication apparatus displays the entire window screen, the entire window screen is unwantedly displayed in a small size, thereby posing a problem that the visibility of the user of the communication apparatus degrades.

### SUMMARY OF THE INVENTION

The present invention has been made in consideration of the above problem, and provides a technique of improving the visibility of a display screen in an apparatus having a small screen size when sharing the display screen between a plurality of apparatuses.

According to one aspect of the present invention, an information processing apparatus includes: a communication unit configured to receive data of a display screen including a plurality of display elements from another communication apparatus; a display control unit configured to cause a display unit to display the plurality of display elements associated with the data received by the communication unit to be switchable in accordance with a user instruction; and a notification unit configured to notify a user of reception of data of a new display element by the communication unit in response to the reception.

According to another aspect of the present invention, a control method for an information processing apparatus, includes: receiving, by a communication unit, data of a display screen including a plurality of display elements from another communication apparatus; causing, by a display control unit, a display unit to display the plurality of display elements associated with the data received by the communication unit to be switchable in accordance with a user instruction; and notifying, by a notification unit, a user of reception of data of a new display element by the communication unit in response to the reception.

According to still another aspect of the present invention, an information processing system includes: an input apparatus configured to generate, based on an input of an operation of an operator, data of a display screen including a plurality of display elements; an intermediate apparatus configured to relay, to an information processing apparatus, the data of the display screen generated by the input apparatus; and the information processing apparatus configured to display the data of the display screen relayed by the intermediate apparatus, the information processing apparatus including a communication unit configured to receive the data of the display screen, a display control unit configured to cause a display unit to display the plurality of display elements associated with the data received by the communication unit to be switchable in accordance with a user instruction, and a notification unit configured to notify a user of reception of data of a new display element by the communication unit in response to the reception.

According to yet another aspect of the present invention, a non-transitory computer-readable storage medium storing a computer program for causing a computer to function as each unit of an information processing apparatus includes: a communication unit configured to receive data of a display screen including a plurality of display elements from another communication apparatus; a display control unit configured to cause a display unit to display the plurality of display elements associated with the data received by the communication unit to be switchable in accordance with a user instruction; and a notification unit configured to notify a user of reception of data of a new display element by the communication unit in response to the reception.

Further features of the present invention will become apparent from the following description of exemplary embodiments (with reference to the attached drawings).

### BRIEF DESCRIPTION OF THE DRAWINGS

FIG. 1 is a view showing an example of the configuration of a teleconference system;

FIG. 2 is a block diagram showing an example of the hardware arrangement of a mobile apparatus;

FIG. 3 is a block diagram showing an example of the functional module arrangement of the mobile apparatus;

FIGS. 4A and 4B are views each showing an example of an entire window screen displayed on a display device;

FIGS. 5A, 5B, 5C, and 5D are views each showing an example of a window screen displayed on the mobile apparatus;

FIG. 6 is a block diagram showing an example of the data structure of entire window screen data information;

FIGS. 7A and 7B are sequence charts showing message examples when displaying a window screen;

FIG. 8 is a sequence chart showing message examples when updating the window screen;

FIG. 9 is a sequence chart showing message examples when switching the window screen;

FIG. 10 is a flowchart illustrating an operation procedure when displaying the window screen;

FIG. 11 is a flowchart illustrating an operation procedure when updating the window screen; and

FIG. 12 is a flowchart illustrating an operation procedure when switching the window screen.

### DESCRIPTION OF THE EMBODIMENTS

An embodiment of the present invention will be described below with reference to the accompanying drawings. Note that the following embodiment is not intended to limit the present invention related to the scope of the claims, and not all of the combinations of features set forth in the embodiment are necessarily essential to the present invention.

System Configuration

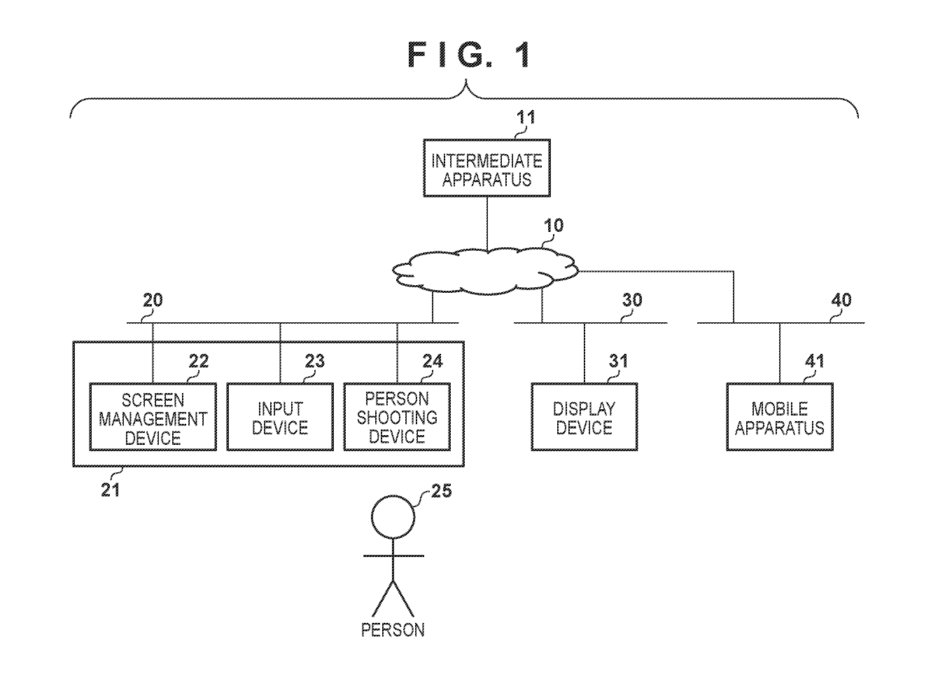

FIG. 1 is a view showing an example of the configuration of a teleconference system as an information processing system according to an embodiment of the present invention. The teleconference system is formed by connecting sites 20, 30, and 40 to a network 10, and can synchronously display the entire display screen of an entire window screen between the sites via an intermediate apparatus 11 in real time. In this embodiment, in the teleconference system for the three sites, entire window screen data created at the site 20 is transmitted to the sites 30 and 40, and the entire window screen is synchronously displayed at the sites 30 and 40 in real time. Although this embodiment will explain an example in which entire window screen data is created at the site 20, the present invention is not limited to this. For example, entire window screen data may be created by a screen management server (not shown) on the network 10, and transmitted to the sites 20, 30, and 40, and then the entire window screen may be synchronously displayed at the respective sites in real time. Although this embodiment will mainly describe an example in which the entire window screen is displayed, the entire window screen need not be displayed. For example, the user may be able to designate a window screen which is not displayed at another site, or a window screen which satisfies preset conditions may be set not to be displayed at another site.

At the site 20, a screen management device 22, an input device 23, and a person shooting device 24 are installed, and a person 25 as an operator of these devices attends a conference. At the site 30, a display device 31 is installed, and a person (not shown) attends the conference. At the site 40, a mobile apparatus 41 as an information processing apparatus according to this embodiment is installed, and a person (not shown) attends the conference. Note that an audio microphone, loudspeaker, PC (Personal Computer), smartphone, tablet, and the like may be installed at each of the sites 20 and 30, and audio and data may be shared between the sites.

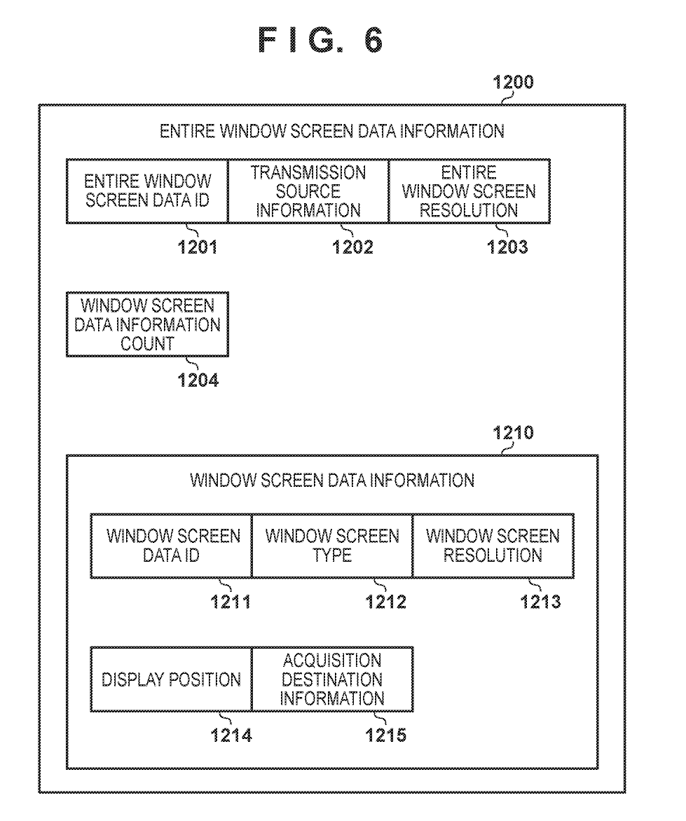

The screen management device 22 creates entire window screen data necessary to draw the entire window screen, and transmits it to the intermediate apparatus 11. The entire window screen data includes data, operation data, and person video data of each window screen in the entire window screen. Details will be described later with reference to FIG. 6. In this embodiment, the above-describe type of data have been described as the entire window screen data. The present invention, however, is not limited to this, and other display element data such as event data, screen control data, audio data, file data, and document data about a window screen may be used. Furthermore, the screen management device 22 transmits entire window screen data information about the entire window screen data to the intermediate apparatus 11. The screen management device 22 has a display function, and displays the entire window screen created for the person 25.

The screen management device 22 receives operation data input from the input device 23. Based on the operation data, the screen management device 22 opens/closes and moves a window on the window screen, and changes the size of the window. Based on the operation data, the screen management device 22 displays an operation trail in the window screen. Practical examples of the screen management device 22 are a PC, note PC, and server.

The input device 23 accepts operation data for operating the window screen from the person 25, and transmits it to the screen management device 22. Practical examples of the input device 23 are a pointing device, keyboard, touch panel, and digitizer. Note that the input device 23 and the screen management device 22 can be connected using a method such as USB (Universal Serial Bus) or LAN (Local Area Network).

The person shooting device 24 performs shooting near the screen management device 22 or input device 23, or in the site 20, and transmits, to the intermediate apparatus 11, as part of the entire window screen data generated by the screen management device 22, person video data obtained by clipping the person 25 from the shot video. Practical examples of the person shooting device 24 are a digital camera, digital video camera, and network camera.

The intermediate apparatus 11 receives the entire window screen data and entire window screen data information from the screen management device 22. The intermediate apparatus 11 transfers the received entire window screen data and entire window screen data information to the display device 31 and the mobile apparatus 41.

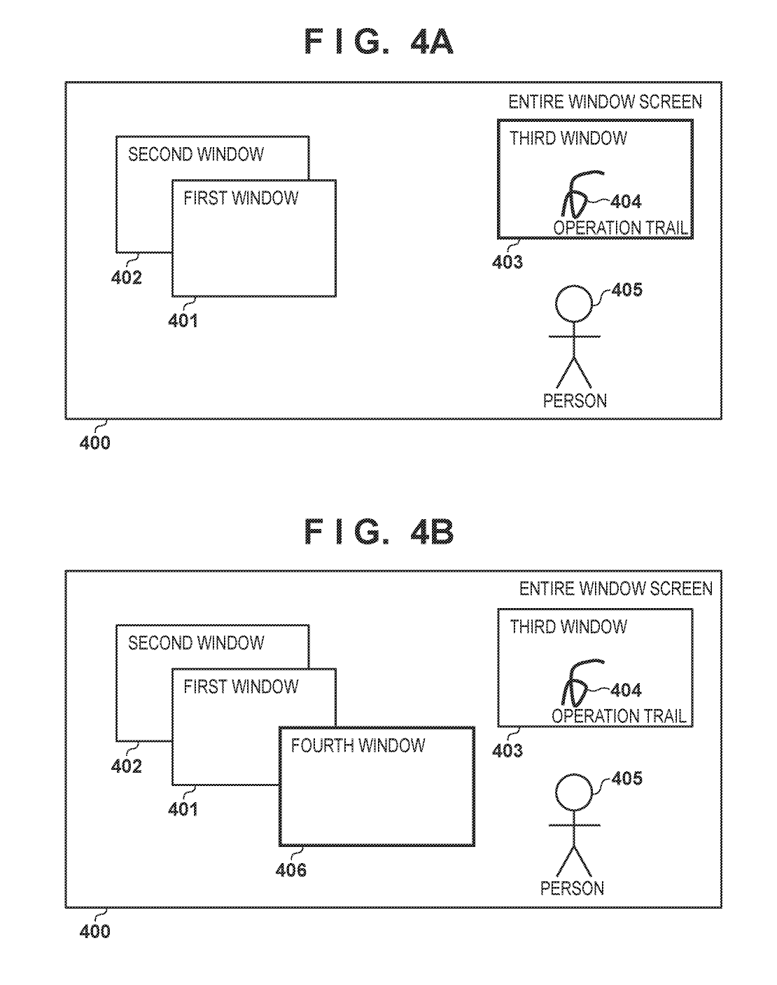

The display device 31 receives the entire window screen data from the intermediate apparatus 11, displays the entire window screen generated by the screen management device 22, and displays an operation trail in the window screen based on the operation data. In this embodiment, assume that the display device 31 has a capability of displaying the resolution of the entire window screen created by the screen management device 22. Therefore, the display device 31 and the screen management device 22 synchronously display the same entire window screen in real time. The practical examples of the display device 31 are a PC, note PC, server, TV, monitor, and projector. Note that examples of the entire window screen displayed on the display device 31 will be described later with reference to FIGS. 4A and 4B.

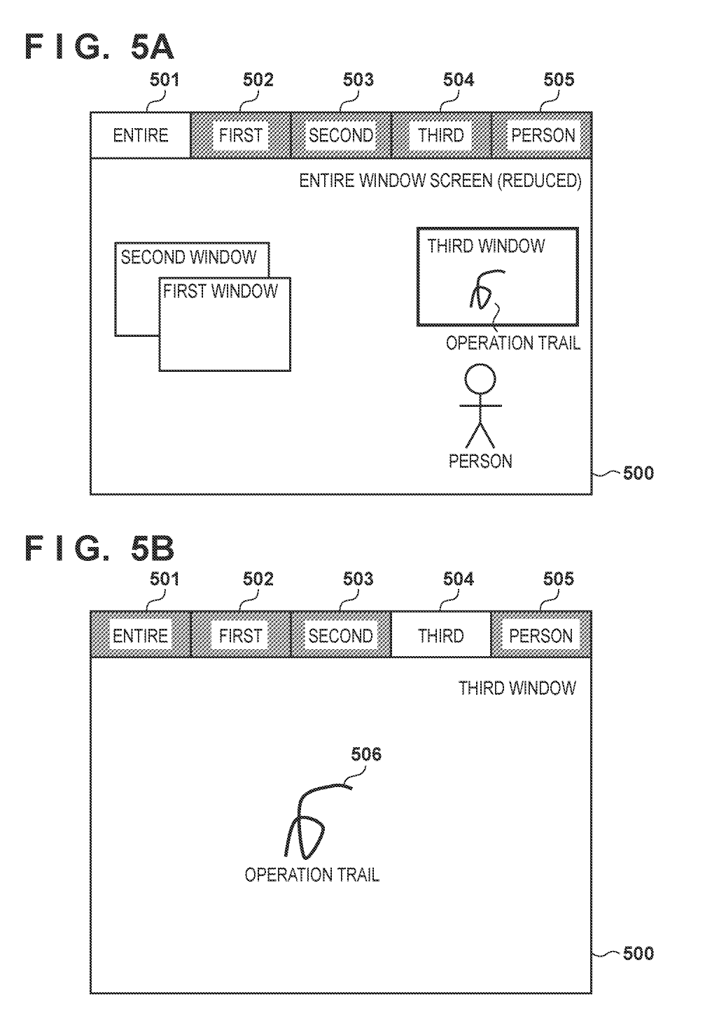

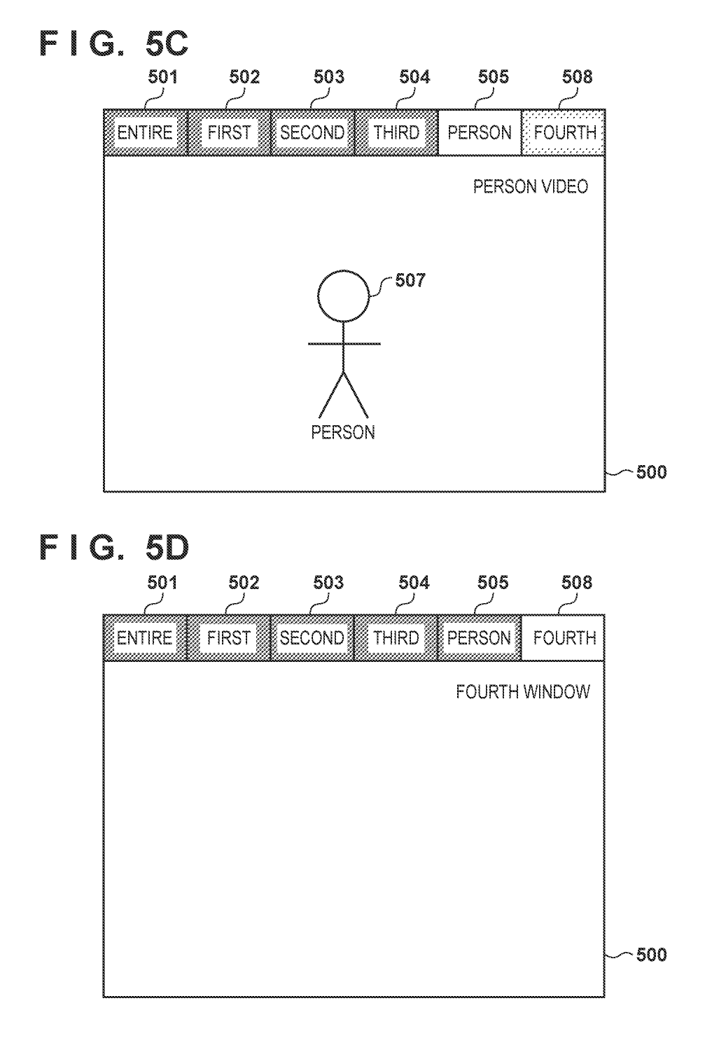

The mobile apparatus 41 serves as a communication apparatus according to this embodiment. The mobile apparatus 41 receives the entire window screen data from the intermediate apparatus 11, and analyzes the entire window screen data, thereby switching and displaying the window screen for each person video or each window screen in the entire window screen. Note that examples of the window screen displayed on the mobile apparatus 41 will be described later with reference to FIGS. 5A, 5B, 5C, and 5D.

Hardware Arrangement

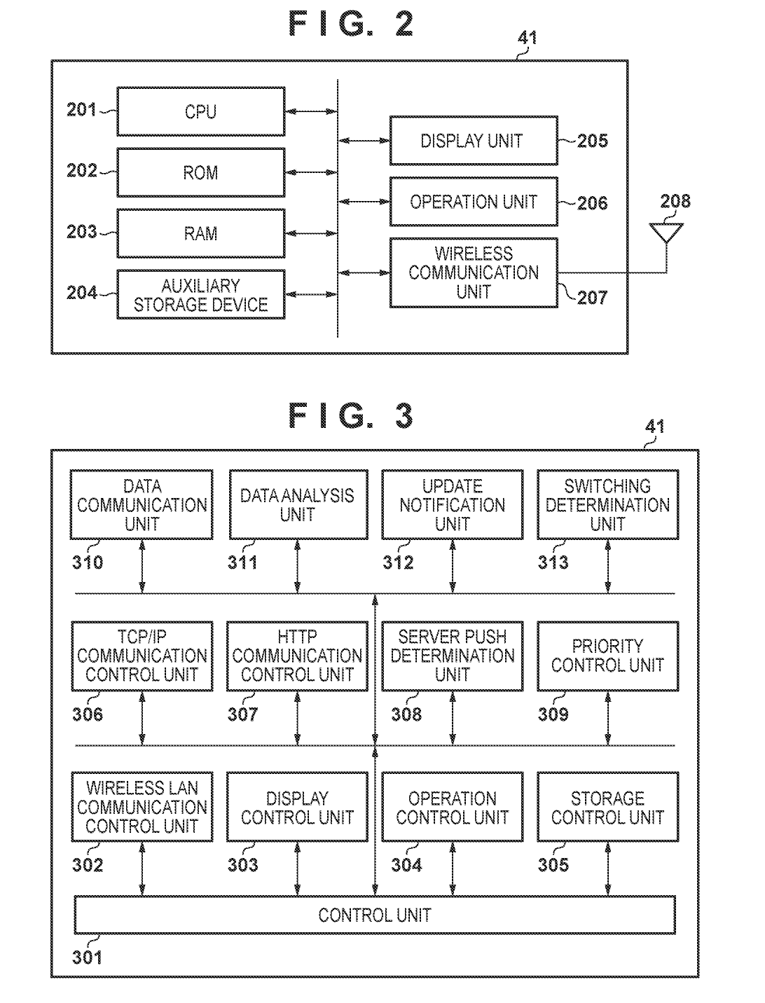

FIG. 2 is a block diagram showing an example of the hardware arrangement of the mobile apparatus 41 according to this embodiment. The mobile apparatus 41 includes a CPU (Central Processing Unit) 201, a ROM (Read Only Memory) 202, a RAM (Random Access Memory) 203, and an auxiliary storage device 204. The mobile apparatus 41 further includes a display unit 205, an operation unit 206, a wireless communication unit 207, and an antenna 208. The CPU 201 controls the overall mobile apparatus 41. The ROM 202 stores computer programs and parameters which need not be changed. The RAM 203 temporarily stores computer programs and data supplied from the auxiliary storage device 204 or the like. The auxiliary storage device 204 stores data such as an image content and video content. The display unit 205 displays a GUI (Graphical User Interface) to be used by the user to operate the mobile apparatus 41. The operation unit 206 serves as an input interface used by the user to operate the mobile apparatus 41. The wireless communication unit 207 controls the antenna 208 to perform wireless LAN communication with a wireless access point (not shown).

Functional Module Arrangement

FIG. 3 is a block diagram showing an example of the functional module arrangement of the mobile apparatus 41 according to this embodiment.

A control unit 301 controls all the functional modules of the mobile apparatus 41. A wireless LAN communication control unit 302 controls the wireless communication unit 207 to perform communication control of a wireless LAN communication method with the wireless access point (not shown). A display control unit 303 controls the display unit 205 to perform display control of the GUI in the mobile apparatus 41. As will be described later, the display control unit 303 causes the display unit 205 to display a plurality of display elements such as a window screen, operation data, and person video associated with data received from the intermediate apparatus 11 to be switchable in accordance with a user instruction.

An operation control unit 304 controls the operation unit 206 to perform operation input control from the user in the mobile apparatus 41. A storage control unit 305 controls the RAM 203 or auxiliary storage device 204 to store or delete processing data or data such as an image content or video content.

A TCP/IP communication control unit 306 performs communication control of the TCP (Transmission Control Protocol)/IP (Internet Protocol) method with the intermediate apparatus 11 using the wireless LAN communication control unit 302. Note that an example of using TCP/IP communication will be explained in this embodiment. The present invention, however, is not limited to this, and another communication protocol such as UDP (User Datagram Protocol) may be used.

The HTTP communication control unit 307 performs communication control of the HTTP/2 method with the intermediate apparatus 11 using the TCP/IP communication control unit 306. Furthermore, an HTTP communication control unit 307 performs communication control of the HTTPS (HTTP Security) method using TLS (Transport Layer Security) with the intermediate apparatus 11.

At the time of HTTP/2 communication connection to the intermediate apparatus 11, a server push determination unit 308 determines whether a server push has been received from the intermediate apparatus 11. More specifically, at the time of HTTP/2 communication connection to the intermediate apparatus 11, the server push determination unit 308 determines whether a PUSH_PROMISE frame has been received from the intermediate apparatus 11. The mobile apparatus 41 is notified of the PUSH_PROMISE frame when reserving a new sub-screen for displaying the window screen data. If the PUSH_PROMISE frame has been received, when a HEADERS frame is received from the intermediate apparatus 11 for a stream reserved by the PUSH-PROMISE frame, it is determined that a server push has been received. As will be described later, in this embodiment, new window screen data is transmitted/received by push communication. Note that the stream indicates a logical communication path established in the connection established between the apparatuses.

A priority control unit 309 performs priority control for each stream in HTTP/2 communication with the intermediate apparatus 11. As will be described later, in this embodiment, the priority level of each stream is set in accordance with the contents/type of window screen data, the display screen is switched in accordance with the priority level, and then whether to continue the stream reception of window screen data corresponding to the screen before switching is controlled.

A data communication unit (window screen data communication unit) 310 communicates the entire window screen data and entire window screen data information with the intermediate apparatus 11. In this embodiment, the data communication unit 310 associates each of the data, operation data, and person video data of each window screen in the entire window screen data with each stream in the HTTP/2 communication with the intermediate apparatus 11. The data communication unit 310 communicates each of the various data with the intermediate apparatus 11 as a data frame in each stream in the HTTP/2 communication. As describe above, in this embodiment, a stream is established for each of a plurality of display elements, and data of each display element is transmitted/received using the corresponding stream. The mobile apparatus 41 updates the display contents of a display element displayed on the display unit 205 in accordance with the received data stream.

Note that the data, operation data, and person video data of each window screen in the entire window screen will be referred to as window screen data (window), window screen data (operation), and window screen data (person video), respectively, hereinafter. The respective data of the window screen, operation, and person video as the display elements forming the entire window screen will be collectively referred to as window screen data hereinafter. That is, the types of window screen data include a window screen, operation, and person. Furthermore, information about window screen data will be referred to as window screen data information hereinafter.

A data analysis unit (window screen data analysis unit) 311 analyzes the entire window screen data, entire window screen data information, window screen data, and window screen data information which have been received by the HTTP/2 communication with the intermediate apparatus 11.

An update notification unit (window screen update notification unit) 312 determines whether the entire window screen data received from the intermediate apparatus 11 includes new window screen data. If new window screen data is included, the update notification unit 312 notifies the user of the presence of a new window screen in the entire window screen by displaying it on the display unit 205 using the display control unit 303 of the mobile apparatus 41.

Using the operation control unit 304, a switching determination unit (window screen switching determination unit) 313 determines whether the user of the mobile apparatus 41 has instructed to switch the window screen displayed on the display unit 205. If the user has instructed to switch the window screen, the switching determination unit 313 uses the display control unit 303 to switch the displayed window screen to the instructed window screen and display it.

Display Screen

FIGS. 4A and 4B are views each showing an example of the entire window screen displayed on the display device 31 according to this embodiment.

FIG. 4A shows an example in which the person 25 uses the input device 23 to draw an operation trail 404 on a third window screen 403 in an entire window screen 400 at the site 20. In this example, the third window screen 403 is an active window in the entire window screen 400.

FIG. 4B shows an example in which the person 25 uses the input device 23 to newly open a fourth window screen 406 in the entire window screen 400 at the site 20. In this example, the fourth window screen 406 is an active window in the entire window screen 400.

The entire window screen 400 indicates the whole of the window screen displayed on the display device 31. A first window screen 401, a second window screen 402, and the third window screen 403 are window screens in the entire window screen 400. The operation trail 404 is a trail drawn on the third window screen 403 in the entire window screen 400 by the person 25 using the input device 23 at the site 20. A person video 405 is obtained by clipping the region of the person from a shot image obtained when the person shooting device 24 shoots the person 25 at the site 20. The fourth window screen 406 is a window screen newly opened in the entire window screen 400 by the person 25 using the input device 23 at the site 20.

FIGS. 5A, 5B, 5C, and 5D are views each showing an example of the window screen displayed on the mobile apparatus 41 according to this embodiment.

FIG. 5A shows an example in which a tab 501 is selected to reduce and display the whole of the window screen in a window screen 500. FIG. 5B shows an example in which a tab 503 is selected to display the third window screen in the window screen 500. FIG. 5C shows an example in which a tab 505 is selected to display, in the window screen 500, a person video obtained by clipping the region of the person from a shot image obtained when the person shooting device 24 shoots the person 25 at the site 20. FIG. 5C shows an example in which when the person 25 newly opens the fourth window screen in the entire window screen using the input device 23 at the site 20, a tab 508 for notifying the mobile apparatus 41 of the presence of the fourth window screen is newly displayed. FIG. 5D shows an example in which the tab 508 is selected to display the newly opened fourth window screen in the window screen 500.

The window screen 500 is a region where a window screen corresponding to a selected one of the tabs 501, 503, and 505 and tabs 502 and 504 is displayed. Note that data about the first to fourth window screens is transmitted from the intermediate apparatus 11 to the mobile apparatus 41 as the window screen data (window) of the entire window screen data. Data about the person video is transmitted as window screen data (person) of the entire window screen data, and data about the operation trail is transmitted as the window screen data (operation).

The tab 501 corresponds to reduced display of the entire window screen. If the tab 501 is selected, the whole of the window screen is reduced and displayed in the window screen 500. The tabs 502 to 504 correspond to display of the first to third windows, respectively. If each of the tabs 502 to 504 is selected, the corresponding window screen is displayed in the window screen 500. The tab 505 corresponds to person video display. If the tab 505 is selected, a person video 507 is displayed in the window screen 500. The tab 508 corresponds to display of the newly opened fourth window screen. If the tab 508 is selected, the fourth window screen is displayed in the window screen 500.

As described above, by a tab format which allows switching of a display element displayed on the display unit 205 by selectably displaying tabs (images) for selecting one of a plurality of display elements, the user can display a desired one of the plurality of display elements. Furthermore, by selectably displaying a tab for selecting a new display element in response to reception of the new display element, the user can readily confirm that the new display element has been added.

When notifying the user of reception of a new display element by an image such as a tab, it is possible to more effectively notify the user of the reception of the new display element by emphatically displaying the image. For example, emphatic display can be implemented by displaying the tab corresponding to the new display element using a color different from that of other tabs, blinking the tab, or indicating the addition of the tab using balloon display or the like.

Data Structure

FIG. 6 is a block diagram showing an example of the data structure of the entire window screen data information according to this embodiment.

Entire window screen data information 1200 is attribute information about the entire window screen data. An entire window screen data ID 1201 indicates the identifier of the entire window screen data. Transmission source information 1202 is information about the transmission source of the entire window screen data. Practical examples of the transmission source information 1202 are an IP address, host name, domain name, URI (Unique Resource Identifier), and FQDN (Fully Qualified Domain Name). An entire window screen resolution 1203 is information about the resolution of the entire window screen. A window screen data information count 1204 indicates the number of pieces of window screen data information 1210 included in the entire window screen data information 1200.

The window screen data information 1210 is information about the window screen data, operation data, and person video data included in the entire window screen data. A window screen data ID 1211 indicates the identifier of window screen data. A window screen type 1212 indicates the type of window screen data. In this embodiment, the types of window screen data include window screen data, operation data, and person video data. A window screen resolution 1213 indicates the resolution of the window screen and person video of the window screen data. A display position 1214 indicates the display position of the window screen in the entire window screen. Acquisition destination information 1215 is information about the acquisition destination of the window screen data. Practical examples of the acquisition destination information 1215 are an IP address, host name, domain name, URI, and FQDN. FIG. 6 shows an example in which the entire window screen data information 1200 includes one piece of window screen data information. However, pieces of window screen data information, the number of which is equal to the window screen data information count 1204, are generated. For example, if the screen shown in FIG. 4A is displayed, five pieces of window screen data information respectively corresponding to the first to third window screens 401 to 403, the person video 405, and the operation trail 404 are generated.

Communication Sequence

In this embodiment, the mobile apparatus 41 receives data of the entire display screen including a plurality of display elements from another apparatus, and causes the display unit 205 to display a plurality of display elements associated with the received data to be switchable in accordance with a user instruction. In response to reception of data of a new display element, the mobile apparatus 41 notifies the user of it. Since each display element such as each window screen is displayed instead of displaying the entire display screen intact, even if the screen of the display unit 205 of the mobile apparatus 41 is small and has a low resolution, the user can readily, visually perceive a desired display element. Furthermore, since, in response to reception of data of a new display element, the user is notified of it, even if the entire display screen includes a plurality of display elements, the user can readily recognize that the new display element has been added. Such arrangement will be described in detail below.

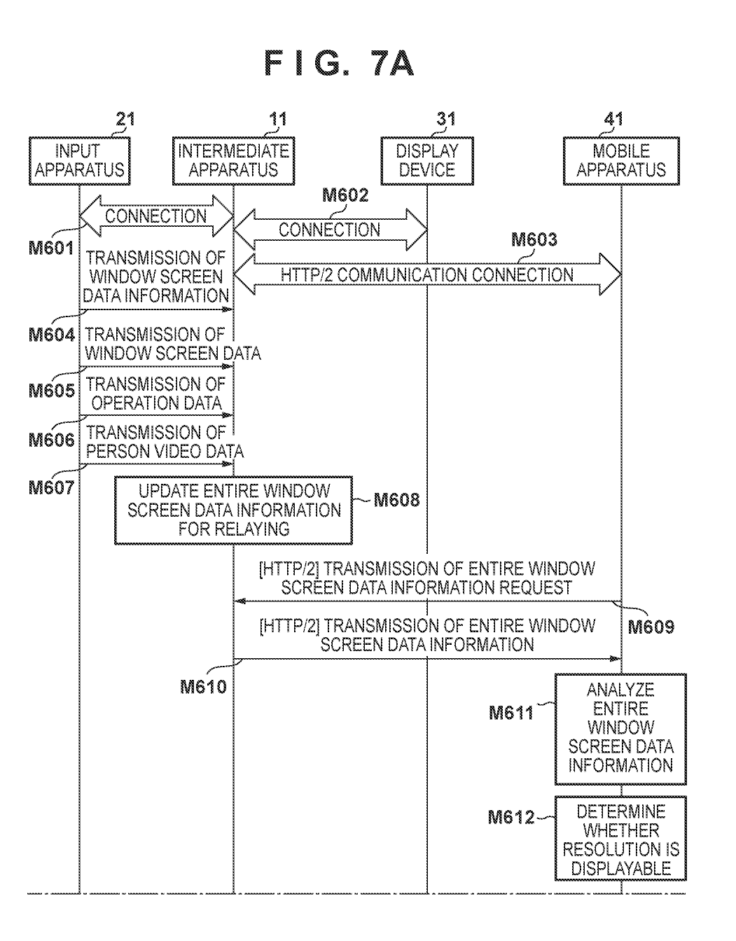

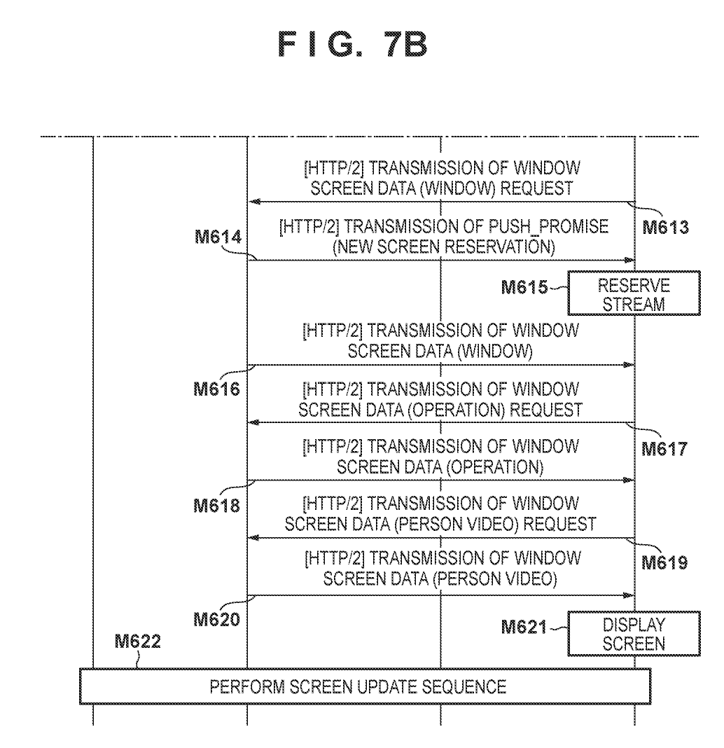

FIGS. 7A and 7B are sequence charts showing message examples when the mobile apparatus 41 displays a window screen according to this embodiment. Note that FIGS. 7A and 7B virtually show the screen management device 22, input device 23, and person shooting device 24 as one input apparatus 21 for the sake of simplicity.

In M601, the input apparatus 21 is communicably connected to the intermediate apparatus 11. This embodiment will exemplify a case in which the communication method between the input apparatus 21 and the intermediate apparatus 11 is HTTP/1.1 communication. However, the present invention is not limited to this. For example, a communication method such as RTP (Realtime Transport Protocol) or RTSP (Real Time Streaming Protocol) may be used.

In M602, the display device 31 is communicably connected to the intermediate apparatus 11. This embodiment will exemplify a case in which the communication method between the display device 31 and the intermediate apparatus 11 is HTTP/1.1 communication. However, the present invention is not limited to this. For example, a communication method such as RTP (Realtime Transport Protocol) or RTSP (Real Time Streaming Protocol) may be used. In this embodiment, a detailed description of a communication sequence between the display device 31 and the intermediate apparatus 11 will be omitted.

In M603, the mobile apparatus 41 performs HTTP/2 communication connection to the intermediate apparatus 11. This embodiment will exemplify a case in which the mobile apparatus 41 serves as an HTTP/2 client and the intermediate apparatus 11 serves as an HTTP/2 server, and then the mobile apparatus 41 requests, of the intermediate apparatus 11, HTTP/2 communication connection.

In M604, the input apparatus 21 transmits the entire window screen data information 1200 to the intermediate apparatus 11. In M605 to M607, the input apparatus 21 transmits the respective window screen data included in the entire window screen to the intermediate apparatus 11. That is, in M605, the input apparatus 21 transmits the window screen data (window screen data (window)) to the intermediate apparatus 11. In M606, the input apparatus 21 transmits the operation data (window screen data (operation)) to the intermediate apparatus 11. In M607, the input apparatus 21 transmits the person video data (window screen data (person)) to the intermediate apparatus 11.

In M608, the intermediate apparatus 11 updates the received the entire window screen data information 1200 for relaying. More specifically, the intermediate apparatus 11 rewrites, by the intermediate apparatus 11, the transmission source information 1202 and acquisition destination information 1215 in the entire window screen data information 1200.

In M609, the mobile apparatus 41 transmits an entire window screen data information request to the intermediate apparatus 11. Note that since this message is transmitted by HTTP/2 communication, [HTTP/2] is described in FIGS. 7A and 7B (the same shall apply hereinafter).

In M610, the intermediate apparatus 11 transmits the updated entire window screen data information 1200 to the mobile apparatus 41. In M611, the mobile apparatus 41 analyzes the received entire window screen data information 1200 to acquire the entire window screen resolution 1203 and the total window screen data information count 1204.

In M612, based on the entire window screen resolution 1203 and the screen size of the display unit 205, the mobile apparatus 41 determines whether it can display the entire window screen. If it is determined that the mobile apparatus 41 can display the entire window screen, the mobile apparatus 41 displays the same screen as the display screen of the display device 31 shown in FIG. 4A or 4B; otherwise, the mobile apparatus 41 displays the window screen in the tab format shown in FIG. 5A, 5B, 5C, or 5D. An example in which the mobile apparatus 41 determines that it cannot display the entire window screen, and determines to display the window screen in the tab format shown in FIG. 5A, 5B, 5C, or 5D will be described below.

In M613, the mobile apparatus 41 transmits a window screen data (window) request to the intermediate apparatus 11 based on the acquisition destination information 1215 of the window screen data information count 1204. In M614, the intermediate apparatus 11 transmits a PUSH_PROMISE frame to the mobile apparatus 41 as a stream reservation for new window screen data. In M615, the mobile apparatus 41 receives the PUSH_PROMISE frame, and reserves a designated stream.

In M616, the intermediate apparatus 11 transmits the window screen data (window) to the mobile apparatus 41. In M617, the mobile apparatus 41 transmits a window screen data (operation) request to the intermediate apparatus 11 based on the acquisition destination information 1215 of the window screen data information count 1204. In M618, the intermediate apparatus 11 transmits the window screen data (operation) to the mobile apparatus 41. In M619, the mobile apparatus 41 transmits a window screen data (person video) request to the intermediate apparatus 11 based on the acquisition destination information 1215 of the window screen data information count 1204. In M620, the intermediate apparatus 11 transmits the window screen data (person video) to the mobile apparatus 41. In M621, based on the received entire window screen data information and various window screen data, the mobile apparatus 41 displays the window screen in the tab format exemplified in FIG. 5A, 5B, 5C, or 5D.

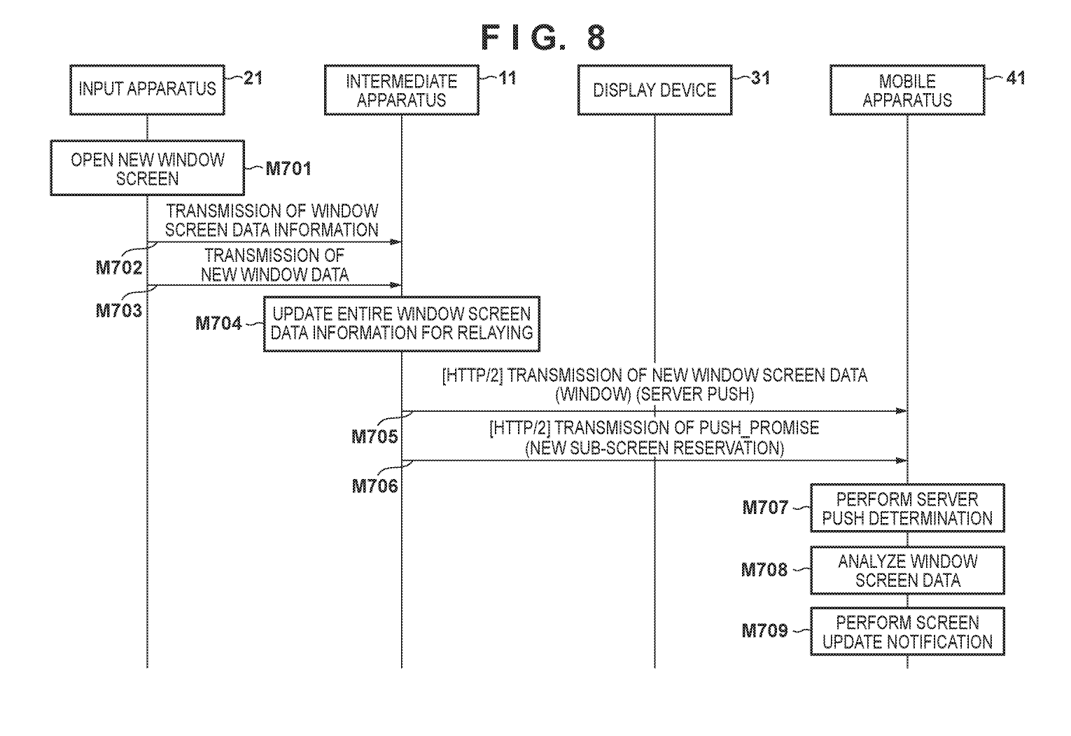

In M622, the screen is updated. A screen update sequence will be described in detail with reference to FIG. 8. FIG. 8 is a sequence chart showing message examples when the mobile apparatus 41 updates the window screen according to this embodiment. Note that FIG. 8 shows processing following the screen display sequence of FIGS. 7A and 7B.

In M701, the input apparatus 21 opens a new window screen. More specifically, an example shown in FIG. 4B in which the person 25 uses the input device 23 to newly open the fourth window screen 406 in the entire window screen 400 at the site 20 will be explained. In M702, the input apparatus 21 transmits, to the intermediate apparatus 11, the entire window screen data information 1200 added with the window screen data information 1210 for the new window screen. In M703, the input apparatus 21 transmits new window screen data to the intermediate apparatus 11.

In M704, the intermediate apparatus 11 updates the received entire window screen data information 1200 for relaying. In M705, the intermediate apparatus 11 transmits new window screen data (window) to the mobile apparatus 41 using the stream reserved in M614 by the HTTP/2 server push method. In M706, the intermediate apparatus 11 transmits a PUSH_PROMISE frame to the mobile apparatus 41 as a stream reservation for the new window screen data.

In M707, the mobile apparatus 41 determines whether the intermediate apparatus 11 has performed a server push. This embodiment will describe an operation example when it is determined that a server push has been performed. In M708, the mobile apparatus 41 analyzes the window screen data received in M705, and determines whether the received data is the new window screen data, that is, whether the received data is the newly added window screen data. This embodiment will exemplify a case in which it is determined that the received data is the new window screen data. In M709, the mobile apparatus 41 notifies the user of itself of the presence of the new window screen. More specifically, the mobile apparatus 41 notifies the user of the presence of the new window screen by newly displaying the tab 508 shown in FIG. 5C.

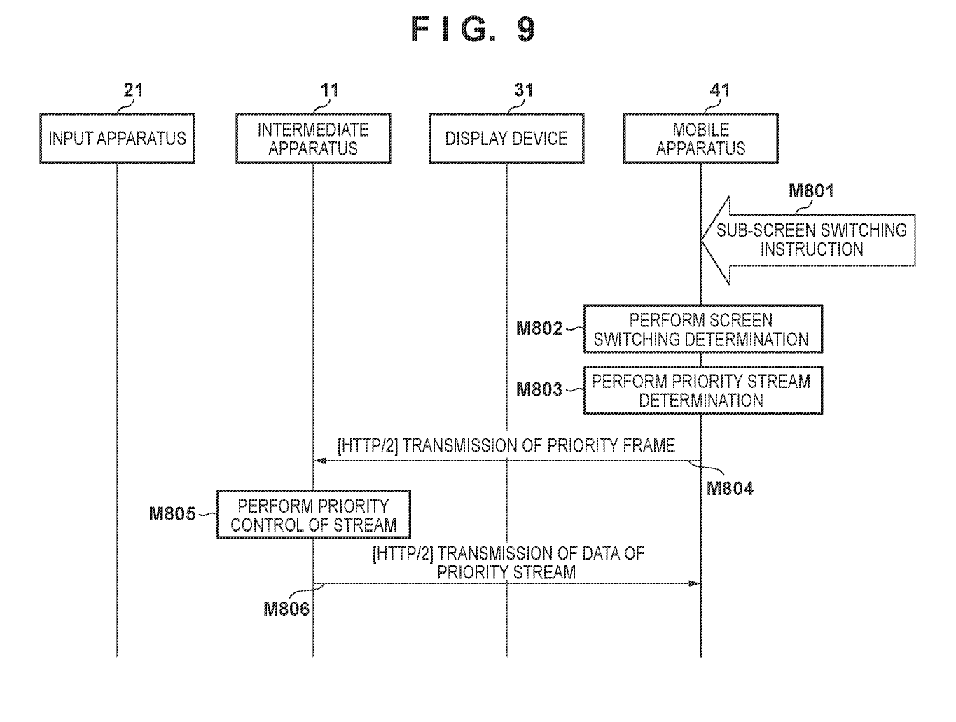

FIG. 9 is a sequence chart showing message examples when the mobile apparatus 41 switches the window screen according to this embodiment.

In M801, the user of the mobile apparatus 41 instructs to switch the window screen. More specifically, switching is instructed when the user selects the tab 508, as shown in FIG. 5D. In M802, the mobile apparatus 41 determines whether to switch the window screen. This embodiment will exemplify a case in which since switching of the window screen has been instructed in M801, the mobile apparatus 41 determines to switch the window screen.

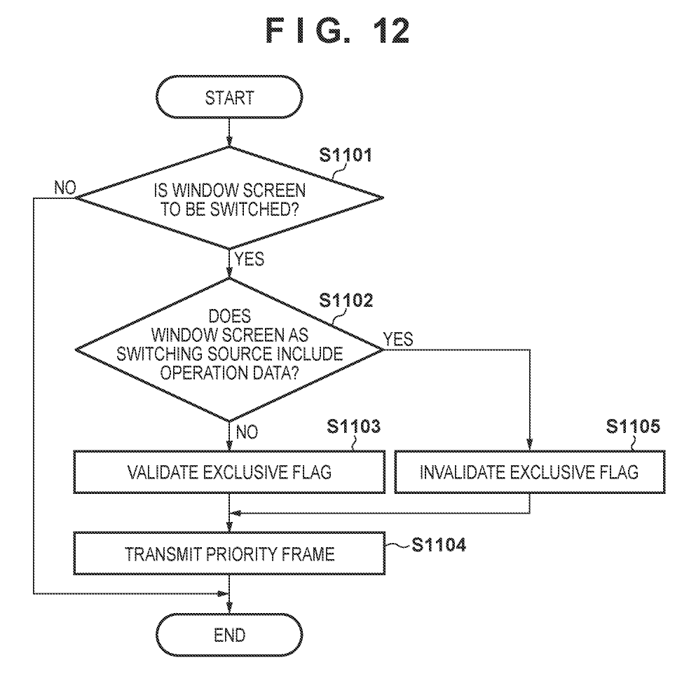

In M803, the mobile apparatus 41 determines priority control of the HTTP/2 stream for receiving the window screen data in order to preferentially receive the window screen data of the window screen to which the mobile apparatus 41 switches the window screen. Priority control will be described in detail later with reference to FIG. 12. This embodiment will explain an example in which the mobile apparatus 41 determines to receive the selected window screen data with top priority. In M804, the mobile apparatus 41 transmits, to the intermediate apparatus 11, a PRIORITY frame, in which an exclusive flag is validated, for the stream determined to give priority in M803. The PRIORITY frame is a frame indicating, by the exclusive flag, whether to permit parallel transmission/reception of the data stream of the display element displayed before the display is switched while receiving the data stream of the display element to be displayed after the display is switched. If the exclusive flag is validated, parallel transmission/reception is prohibited; otherwise, parallel transmission/reception is permitted.

In M805, the intermediate apparatus 11 performs priority control of the stream in the HTTP/2 communication with the mobile apparatus 41 based on the received PRIORITY frame. In M806, the intermediate apparatus 11 transmits, to the mobile apparatus 41, the window screen data for the stream designated by the PRIORITY frame. On the other hand, the intermediate apparatus 11 stops the transmission of the window screen data transmitted by other streams.

Communication Processing by Mobile Apparatus

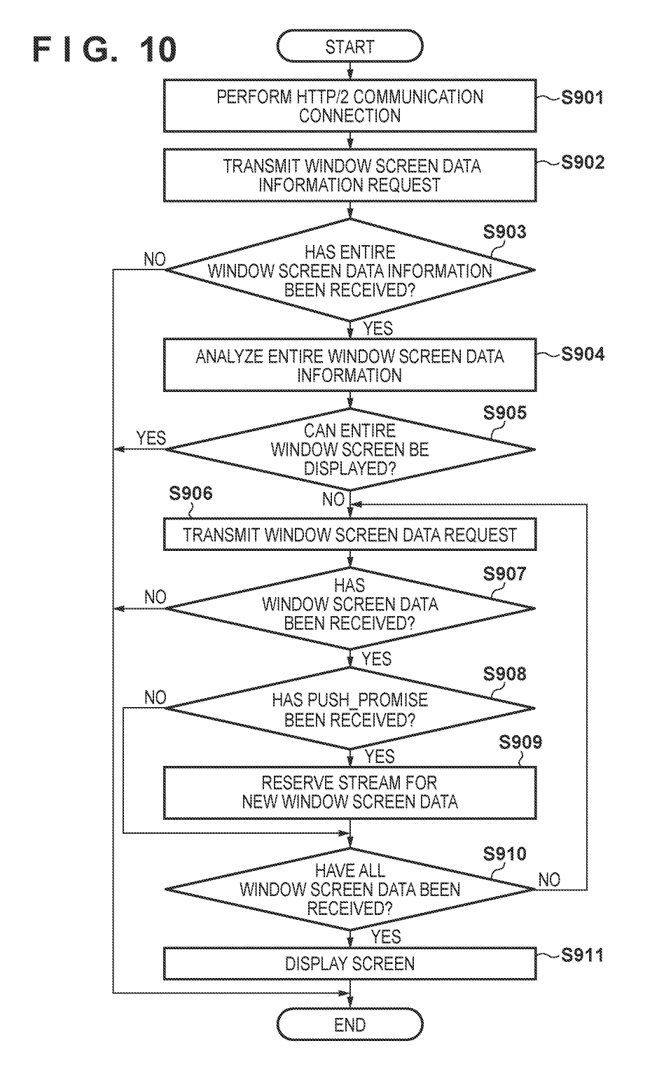

FIG. 10 is a flowchart illustrating an operation procedure when the mobile apparatus 41 displays the window screen according to this embodiment. The following steps are executed under the control of the CPU 201.

In step S901, the HTTP communication control unit 307 performs HTTP/2 communication connection to the intermediate apparatus 11. In step S902, the data communication unit 310 transmits an entire window screen data information request to the intermediate apparatus 11.

In step S903, the data communication unit 310 determines whether the entire window screen data information 1200 has been received from the intermediate apparatus 11. If the entire window screen data information 1200 has been received (YES in step S903), the process advances to step S904; otherwise (NO in step S903), the process ends.

In step S904, the data analysis unit 311 analyzes the received entire window screen data information 1200.

In step S905, based on the entire window screen resolution 1203 in the entire window screen data information 1200, the data analysis unit 311 determines whether the mobile apparatus 41 can display the entire window screen. More specifically, the data analysis unit 311 compares the entire window screen resolution 1203 with the resolution and size displayable on the display unit 205. If the display unit 205 exceeds the entire window screen in terms of these values, the data analysis unit 311 determines that the entire window screen can be displayed. If it is determined that the entire window screen cannot be displayed (NO in step S905), the process advances to step S906; otherwise (YES in step S905), the process ends. If the process ends, the same display processing as that of the display device 31 is performed, and a detailed description thereof will be omitted in this embodiment.

In step S906, the data communication unit 310 transmits a window screen data request to the intermediate apparatus 11 based on the acquisition destination information 1215 of the window screen data information count 1204. In step S907, the data communication unit 310 determines whether the window screen data has been received from the intermediate apparatus 11. If the window screen data has been received (YES in step S907), the process advances to step S908; otherwise (NO in step S907), the process ends.

In step S908, the server push determination unit 308 determines whether the PUSH_PROMISE frame has been received from the intermediate apparatus 11. If the PUSH_PROMISE frame has been received (YES in step S908), the process advances to step S909; otherwise (NO in step S908), the process advances to step S910.

In step S909, the server push determination unit 308 reserves a stream for new window screen data. In step S910, based on the window screen data information 1210, the data communication unit 310 determines whether all the window screen data have been received. If all the window screen data have been received (YES in step S910), the process advances to step S911; otherwise (NO in step S910), the process returns to step S906. In step S911, the display control unit 303 displays the window screen in the tab format shown in FIG. 5A, 5B, 5C, or 5D based on all the received window screen data.

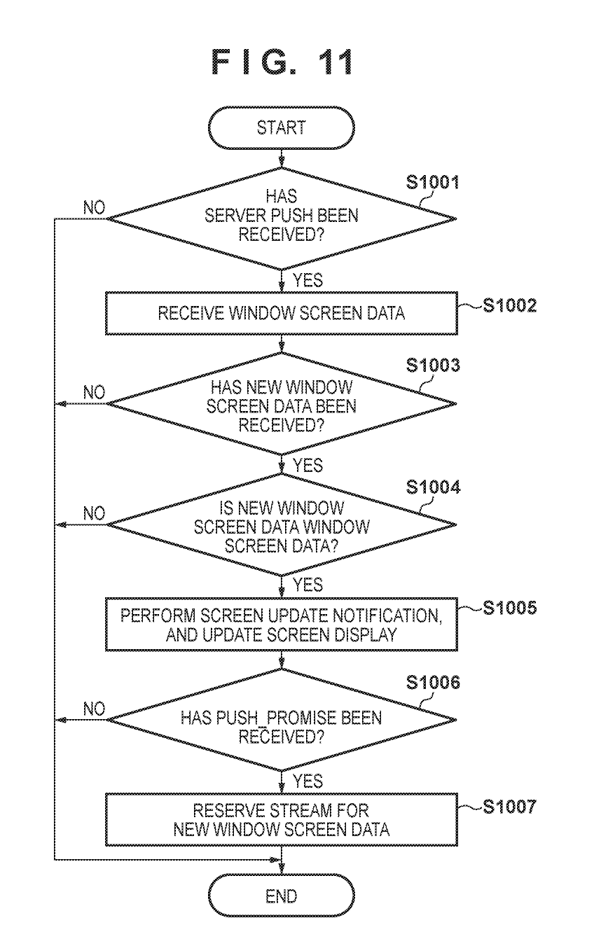

FIG. 11 is a flowchart illustrating an operation procedure when the mobile apparatus 41 updates the window screen according to this embodiment. The following steps are executed under the control of the CPU 201.

In step S1001, the server push determination unit 308 determines whether a server push has been received from the intermediate apparatus 11. More specifically, if the PUSH_PROMISE frame has been received from the intermediate apparatus 11 and the HEADERS frame has been received from the intermediate apparatus 11 for the stream reserved by the PUSH_PROMISE frame, it is determined that a server push has been received. If it is determined that a server push has been received (YES in step S1001), the process advances to step S1002; otherwise (NO in step S1001), the process ends.

In step S1002, the data communication unit 310 receives the window screen data in the stream for which it is determined in step S1001 that the server push has been received. In step S1003, the data analysis unit 311 analyzes the received window screen data, and determines whether the received data is new window screen data. If the received data is new window screen data (YES in step S1003), the process advances to step S1004; otherwise (NO in step S1003), the process ends.

In step S1004, the data analysis unit 311 analyzes the received new window screen data, and determines whether the new window screen data is window screen data (window). If the new window screen data is window screen data (window) (YES in step S1004), the process advances to step S1005; otherwise (NO in step S1004), the process ends.

In step S1005, the update notification unit 312 displays the presence of the new window screen data (window) on the display unit 205 using the display control unit 303. More specifically, the update notification unit 312 displays a new tab like the tab 508 shown in FIG. 5C. The processes in steps S1006 and S1007 are the same as those in steps S908 and S909.

FIG. 12 is a flowchart illustrating an operation procedure when the mobile apparatus 41 switches the window screen according to this embodiment. The following steps are executed under the control of the CPU 201.

In step S1101, the switching determination unit 313 determines whether to switch the window screen. More specifically, the switching determination unit 313 determines whether the user of the mobile apparatus 41 has selected one of the tabs 501 to 508 shown in FIG. 5D. If the user selects the tab, it is determined whether the window screen corresponding to the selected tab is different from that currently selected and displayed on the display unit 205. If the currently selected and displayed window screen is different, it is determined to switch the window screen. If the window screen is to be switched (YES in step S1101), the process advances to step S1102; otherwise (NO in step S1101), the process ends.

In step S1102, the data analysis unit 311 determines whether the window screen data as a switching source includes operation data. If no operation data is included (NO in step S1102), the process advances to step S1003; otherwise (YES in step S1102), the process advances to step S1105.

In step S1103, the priority control unit 309 validates the exclusive flag set in the PRIORITY frame for the HTTP/2 stream for receiving the window screen data in order to exclusively receive the window screen data of the switching destination.

In step S1104, the priority control unit 309 transmits the PRIORITY frame to the intermediate apparatus 11 using the HTTP communication control unit 307, thereby terminating the processing.

In step S1105, the priority control unit 309 invalidates the exclusive flag set in the PRIORITY frame for the HTTP/2 stream for receiving the window screen data in order not to exclusively receive the window screen data of the switching destination. After that, the process advances to step S1104.

As described above, according to this embodiment, based on all the received window screen data, the display control unit 303 displays the window screen in the tab format shown in FIG. 5A, 5B, 5C, or 5D. The server push determination unit 308 determines whether a server push has been received from the intermediate apparatus 11. If a server push has been received, the data analysis unit 311 determines whether the received data is new window screen data (window), that is, data about a new window screen. If new window screen data has been received, the update notification unit 312 displays a new tab for the new window screen using the display control unit 303.

While the user of the mobile apparatus 41 browses the window screen in the tab format shown in FIG. 5A, 5B, 5C, or 5D, it is difficult for him/her to notice the presence of a new window screen since the entire window screen is not displayed. However, as described above, if a new window screen is opened, the mobile apparatus 41 adds a new tab, and it is thus easier for the user to notice the presence of the new window screen, thereby improving the visibility.

Note that this embodiment has described an example in which when data of a new window screen is received, the user is notified of it. However, when another display element such as operation data or a person video is added, the user may be notified of it. This can establish a flexible system according to the application of the teleconference system. Furthermore, this embodiment has explained an example in which data indicating reception of a new display element is displayed on the display unit 205 to notify the user of it. Notification to the user is not limited to the display on the display unit 205. For example, the user may be notified of reception of a new display element by outputting an audio from a loudspeaker (not shown) or vibrating a vibrator.

Furthermore, according to this embodiment, if the user selects another tab which is not currently displayed on the window screen shown in FIG. 5A, 5B, 5C, or 5D, the data analysis unit 311 determines whether the window screen data as the switching source includes operation data. When the currently displayed window screen data includes operation data, if operation data is no longer received by switching, the consistency of the window screen cannot be maintained between the sites 20 and 40. Thus, if operation data is included, when the priority control unit 309 invalidates the exclusive flag set in the PRIORITY frame, it becomes possible to continuously receive the window screen data as the switching source even after the window screen is switched.

On the other hand, if the currently displayed window screen data includes no operation data, there is no problem with the consistency of the window screen, and thus the priority control unit 309 validates the exclusive flag set in the PRIORITY frame. This improves the response performance associated with the display of the window screen as a switching destination, and reduces the data transfer amount of the window screen data as a whole, thereby making it possible to reduce the network traffic.

Although the data analysis unit 311 determines validation/invalidation of the exclusive flag set in the PRIORITY frame based on the presence/absence of the above-described operation data in this embodiment, the present invention is not limited to this. For example, the data analysis unit 311 may determine validation/invalidation of the exclusive flag based on a content displayed on the window screen as a switching source. If the content displayed on the window screen as a switching source is a video, it is impossible to quickly display the window screen as a switching source again unless given video data is continuously cached. In this case, the priority control unit 309 invalidates the exclusive flag set in the PRIORITY frame. This makes it possible to quickly display a video even if the user selects the window screen as a switching source, thereby improving the response performance.

On the other hand, if the content displayed on the window screen as a switching source is a document file or image, it is not necessary to receive the data after switching, and the priority control unit 309 may validate the exclusive flag set in the PRIORITY frame.

Furthermore, the data analysis unit 311 determines whether the window screen data as a switching source includes audio data or event data about a teleconference or control of the window screen. In general, since it is necessary to continuously reproduce an audio during a teleconference, it is necessary to continuously receive the audio data even after the window screen is switched. Similarly, to ensure the consistency of the window screen or teleconference, it is necessary to continuously receive the event data even after the window screen is switched. In this case, the priority control unit 309 invalidates the exclusive flag set in the PRIORITY frame. This can maintain the balance between an improvement in the response performance and the maintenance of the user convenience and the ensuring of the consistency of the system.

If the size of the window screen has been changed to a larger size at the site 20, the data analysis unit 311 may determine whether the window screen resolution 1213 has been changed. If the size has been changed to a larger size, the display control unit 303 may display a scroll bar on the corresponding window screen, thereby allowing display of the entire window screen. Alternatively, the display control unit 303 may reduce the corresponding window screen by the change in size, thereby allowing display of the entire window screen. This improves the visibility of the user.

This embodiment has described an example in which the display control unit 303 displays the window screen in the tab format to be switchable. However, a method of displaying display elements to be switchable is not limited to this, and may be implemented by another display form such as a sub-window, tile, or list form.

According to each of the above-described arrangements, when sharing and synchronously displaying a window screen between remote sites, even a communication apparatus having a low resolution and small screen size can switch and display each window screen in the entire window screen. Furthermore, even if a new window screen is opened in the entire window screen, the user of a communication apparatus readily notices the presence of the new window screen, thereby improving the visibility. Note that this embodiment has mainly explained the case in which the window screen is shared between remote sites. However, the present invention is not limited to this. For example, the above arrangement is applicable when sharing a screen between a plurality of apparatuses having different display screen sizes.

According to the present invention, when sharing a display screen between a plurality of apparatuses, the visibility of the display screen can be improved in an apparatus having a small screen size.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-152700, filed on Jul. 31, 2015, which is hereby incorporated by reference herein in its entirety.

What is claimed is:

1. An information processing apparatus comprising:
a communication unit configured to receive data of a display screen including a plurality of display elements from another communication apparatus;
a display control unit configured to cause a display unit to display the plurality of display elements associated with the data received by the communication unit to be switchable in accordance with a user instruction; and
a notification unit configured to notify a user of reception of data of a new display element by the communication unit in response to the reception.

2. The apparatus according to claim 1, wherein in response to reception of a window screen as the new display element by the communication unit, the notification unit notifies the user of the reception.

3. The apparatus according to claim 1, wherein the notification unit notifies the user of reception of the new display element by displaying an image indicating the reception on the display unit.

4. The apparatus according to claim 3, wherein
the display control unit displays a tab image for selecting a display element to be displayed among the plurality of display elements to be able to switch a display element displayed on the display unit in accordance with a user operation on the tab image, and
in response to reception of the new display element, the notification unit notifies the user of the reception by causing the display unit to display a tab image for selecting the new display element.

5. The apparatus according to claim 4, wherein the notification unit notifies the user of the reception by causing the display unit to emphatically display the tab image for selecting the new display element.

6. The apparatus according to claim 1, wherein the communication unit
establishes a logical communication path for each of the plurality of display elements in a connection established with the other communication apparatus, and
receives, for each of the plurality of display elements, data of the display element by the corresponding communication path.

7. The apparatus according to claim 6, wherein in response to reception, by the communication unit, of the data of the new display element by push communication from the other communication apparatus, the notification unit notifies the user of the reception.

8. The apparatus according to claim 6, wherein
the communication unit receives, by the corresponding communication path, a data stream of the display element displayed on the display unit, and
the display control unit updates display contents of the display element displayed on the display unit in accordance with the data stream received by the communication unit.

9. The apparatus according to claim 8, further comprising:
a determination unit configured to determine, in response to an instruction to switch the display element displayed on the display unit, whether to continue the reception of the data stream of the display element displayed on the display unit,
wherein if the determination unit determines to continue the reception, the communication unit receives a data stream of the display element to be displayed after the display is switched while receiving the data stream of the display element displayed before the display is switched.

10. The apparatus according to claim 9, wherein based on a type of the display element displayed on the display unit, the determination unit determines whether to continue the reception of the data stream of the display element.

11. The apparatus according to claim 9, wherein if the determination unit determines to continue the reception, the communication unit receives the data stream of the display stream to be displayed after the display is switched without receiving the data stream of the display element displayed before the display is switched.

12. The apparatus according to claim 1, wherein the display control unit causes the display unit to display the display screen including the plurality of display elements in accordance with a user instruction.

13. A control method for an information processing apparatus, comprising:
receiving, by a communication unit, data of a display screen including a plurality of display elements from another communication apparatus;
causing, by a display control unit, a display unit to display the plurality of display elements associated with the data received by the communication unit to be switchable in accordance with a user instruction; and
notifying, by a notification unit, a user of reception of data of a new display element by the communication unit in response to the reception.

14. An information processing system comprising:
an input apparatus configured to generate, based on an input of an operation of an operator, data of a display screen including a plurality of display elements;
an intermediate apparatus configured to relay, to an information processing apparatus, the data of the display screen generated by the input apparatus; and
the information processing apparatus configured to display the data of the display screen relayed by the intermediate apparatus,
the information processing apparatus including
a communication unit configured to receive the data of the display screen,
a display control unit configured to cause a display unit to display the plurality of display elements associated with the data received by the communication unit to be switchable in accordance with a user instruction, and
a notification unit configured to notify a user of reception of data of a new display element by the communication unit in response to the reception.

15. A non-transitory computer-readable storage medium storing a computer program for causing a computer to function as each unit of an information processing apparatus comprising:
a communication unit configured to receive data of a display screen including a plurality of display elements from another communication apparatus;
a display control unit configured to cause a display unit to display the plurality of display elements associated with the data received by the communication unit to be switchable in accordance with a user instruction; and
a notification unit configured to notify a user of reception of data of a new display element by the communication unit in response to the reception.
